(19) United States
(12) Patent Application Publication
(10) Pub. No.: US 2019/0116763 A1
(43) Pub. Date: Apr. 25, 2019

(54) Retractable Self-Storing Leash

(71) Applicant: Ron-Paul Dunnum, Laguna Beach, CA (US)

(72) Inventor: Ron-Paul Dunnum, Laguna Beach, CA (US)

(21) Appl. No.: 16/168,450

(22) Filed: Oct. 23, 2018

Related U.S. Application Data
(60) Provisional application No. 62/575,721, filed on Oct. 23, 2017.

(51) Int. Cl. A01K 27/00

(52) U.S. Cl. CPC A01K 27/004; A01K 27/005

(57) ABSTRACT

A self retracting leash has a flexible leash member extending from a first end to a handle. The leash member is biased by an elastic cord or biased roller to move to a contracted configuration within an interior cavity of a flexible container. An endwall of the flexible container is adapted for removable engagement to a leash of an animal such as a dog. The bias to the contracted configuration imparts a bias of the removable engagement to the leash toward the handle end of the leash member.

This application claims priority to U.S. Provisional patent application Ser. No. 62/575,721, filed on Oct. 23, 2017, which is incorporated herein in its entirety by this reference thereto.

### BACKGROUND OF THE INVENTION

### 1. Field of the Invention

The present invention relates generally to leashes. More particularly, it relates to a leash such as those conventionally employed to restrain dogs and pets, which is configured to retract and self-store within an included leash container.

### 2. Prior Art

Pet owners desiring to walk their pet, such as a dog, conventionally will engage a first end of a tether to the dog, such as to a collar, and hold the second end of the tether in their hand during the sojourn with their dog. The same is true for other animals which an owner might wish to walk with for a pleasure walk, or to restrain during movement between pens or animal housing. Indeed with a dog, who is frequently considered a member of the family, a leash is a necessity in a city environment where a walk will generally take the owner and dog along streets and highways and passing cars thereon. Most dogs are not adept at looking before crossing a street, and a tether such as a leash is a must for their safety.

While retracting leashes exist, conventional retracting leashes generally have a hard housing surrounding a winding reel for the tether serving as the leash. They are bulky due to the housing and spring loaded mechanism within the housing required to unwind and retract the reeled tether serving as the leash.

Additionally, they are heavy.

Because of such construction, such retractable leashes are not easily carried in a pocket due to their large size. Further, even when having a smaller component housing, their weight makes them inconvenient for carrying in a pocket or purse.

Non-retractable leashes, generally formed of cord, rope, or webbing, weigh less than mechanically housed retractable leashes. However, because they are elongated, they must be wound to carry in a pocket or purse or the like, and being elongated, they will tend to unwind or become tangled when stored in such confines.

Because of the weight and bulk of retractable leashes, and the elongation and tangling of non-retractable leashes, many owners simply do not carry one on their person. As a consequence, pet owners desiring a tether such as a leash to control and maintain their pet on a safe but enjoyable walk, find themselves without the required leash being handy and ready to use on many occasions. This is especially true on spur of the moment occasions where an unplanned walk or movement of a pet is desired or required.

The self-storing retracting leash device herein remedies a number of the shortcomings of prior art. The disclosed device is lightweight, like that of a non-retractable elongated leash. Concurrently though, the device is configured to self-retract to a compact state positioned within a flexible container formed as an integral component of the leash herein.

It should be noted, the foregoing examples of related art for animal tethers and the like and limitations related therewith are intended to be illustrative and not exclusive, and they do not imply any limitations on the leash systems described and claimed herein. Various limitations of the related art are already known or will become apparent to those skilled in the art upon a reading and understanding of the specification below and the accompanying drawings.

An object of the present invention is the provision of a lightweight tether employable as a leash for a pet such as a dog, or other animal needing restraint during movement.

Another object of the present invention is to provide such a lightweight leash, which is also retractable using retracting components integral to the elongated flexible tether.

A further object of the invention is to provide such a self-retracting leash which is configured with an integral storage compartment into which the flexible tether forming the leash will self-retract.

Further objectives of the retracting leash system herein will be brought out in the following parts of the specification wherein the summary and detailed description of the invention are for the purpose of fully disclosing the invention without placing limitations thereon.

### SUMMARY OF THE INVENTION

The present invention provides a device and method solving the shortcomings and dilemma in the art of leashes employed for restraint and tethering of animals and pets.

The disclosed device herein, and a number of modes shown, features a flexible tether component, having an axial passage in which a user actuable or automatic elastic cord is positioned. In all modes a flexible container having an internal cavity adapted to hold and contain the retracted flexible tether component is included as an integral and permanently engaged component of the leash device.

In one mode, the elongated flexible member or tether forming the flexible leash has a first end adapted to removably engage to an animal such as to a dog or other animal collar. At a second end, opposite this first end of the flexible leash member, is located a handle which is formed to provide the user an easy grip upon the second end of the leash.

In this first mode, running axially within a passage formed in the elongated flexible member forming the leash, is situated an elongated flexible elastic cord or member which is engaged at a second end to the handle end, and at a first end, to a ring or similar user-gripped attachment. The elastic member has an elongated length which, when stretched, allows the flexible leash member forming the leash to elongate to a length which is a multiple of a contracted configuration. This elastic cord or member running axially in the leash member, when not elongated by force on both ends of the surrounding flexible leash, will elastically retract to a contracted configuration. In moving from the elongated configuration to the contracted configuration, the elastic member will also cause the flexible leash member to contract to a compact state. A second end of the elastic cord or member, can be engaged with a ring or user actuable connector which will allow the user to pull the semi-retracted flexible leash member, completely into a flexible container.

This flexible container is positioned adjacent the first end of the leash. The flexible container has an interior cavity formed by surrounding flexible sidewall of the flexible container. In the compact state, the leash member will substantially entirely retract into the interior cavity of the flexible container such that a short pull upon the ring or other user actuable connector, will complete the retraction. A closure such an elastic band, or zipper, or hook and loop fabric, may be positioned at an open end of the interior cavity of the flexible container and thereby allow the user to removably close the flexible container once the entire flexible leash member is contracted into the flexible container.

Adjacent the end of the flexible container opposite the open end is positioned a fastener. This fastener is engaged with the second end of the flexible leash member and adapted to removably engage with a connector located on an animal collar such as the collar on a dog.

In another mode of the self retracting leash device herein, the elongated flexible leash member also has a passage running axially in between a first end and second end. Situated at a first end is the removable fastener adapted to removably engage a connector on an animal collar. At the second end, opposite the first end, is located a handle for gripping by the user. Positioned adjacent, the fastener at the first end is located the flexible container which also has an interior cavity formed by surrounding flexible sidewall.

Within the axial passage of the flexible leash member is located a pull cord or the like. At a central position between the first end and second end of the flexible leash member is located a grab point where the user may grip a ring or similar connector which is engaged with the centrally positioned pull cord, to pull the while holding the central portion of the flexible leash member. In doing so, both ends of the flexible leash member are drawn toward the central point, whereupon the flexible leash member will be compacted and retract into the interior cavity of the flexible container. In a similar fashion to the first mode of the device, a closure such as an elastic band, or zipper, or hook and loop fabric, may be positioned at an open end of the interior cavity of the flexible container and thereby allow the user to removably close the flexible container once the entire flexible leash member is contracted into the flexible container.

With respect to the above description, before explaining at least one preferred embodiment of the herein disclosed self retracting leash in detail, it is to be understood that the invention is not limited in its application to the details of construction and to the arrangement in the following description or illustrated in the drawings. The disclosed leash device herein described is capable of other embodiments and of being practiced and carried out in various ways which will become obvious to those skilled in the art upon reading this disclosure. Also, it is to be understood that the phraseology and terminology employed herein are for the purpose of description and should not be regarded as limiting.

As such, those skilled in the art will appreciate that the conception upon which this disclosure is based, may readily be utilized as a basis for the designing of other self retracting leash structures for carrying out the several purposes of the present disclosed device. It is important, therefore, that the claims herein be regarded as including such equivalent construction and methodology, insofar as they do not depart from the spirit and scope of the present invention.

### BRIEF DESCRIPTION OF DRAWING FIGURES

The accompanying drawings, which are incorporated herein and form a part of the specification, illustrate some, but not the only or exclusive examples of embodiments and/or features of the leash invention. It is intended that the embodiments and figures disclosed herein are to be considered illustrative rather than limiting.

In the drawings:

FIG. 1 shows the self retracting leash herein in an elongated configuration such as when engaged to an animal at a first end, and held in the hand of the user at a second end.

FIG. 2 shows the device of FIG. 1, contracting into a compacted state within the cavity of the flexible container once force is removed from both ends.

FIG. 3 depicts the device in all modes herein, once the flexible leash member is fully contracted into the soft container and surrounded by the sidewall of the container.

FIG. 4 is a sectional view through a first end of the leash device of FIG. 1.

FIG. 5 depicts a secondary mode of the device wherein a user activated pull cord runs axially through the elongated flexible leash member.

FIG. 6 shows a sectional view of a portion of the first end of the device as in FIG. 5.

FIG. 7 shows the device herein having the user activated pull cord for collapsing the leash positioned at the flexible container end of the device.

FIG. 8 shows a mode of the device herein having a biased spool which is shown with a portion of an external housing removed, which is positioned within the wall forming the flexible container and showing an optional release for the spool should it lock.

### DETAILED DESCRIPTION OF THE PREFERRED EMBODIMENTS OF THE INVENTION

In this description, any directional prepositions if employed, such as up, upwardly, down, downwardly, front, back, first, second, top, upper, bottom, lower, left, right and other such terms referring to the device or depictions as such may be oriented, are describing it such as it appears in the drawings and are used for convenience only. Such terms of direction and location are not intended to be limiting or to imply that the device herein has to be used or positioned in any particular orientation.

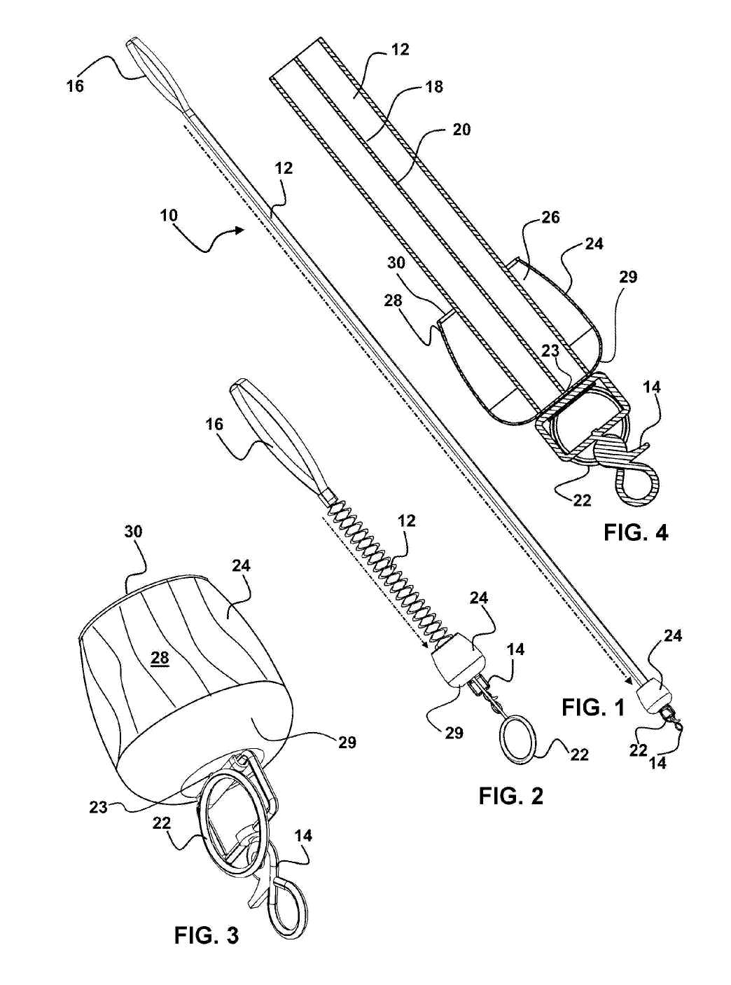

Now referring to drawing of FIGS. 1-8, there is seen in FIG. 1, the device 10 in an elongated configuration. As shown, a flexible leash member 12 is in a connection at a first end with an endwall 29 of the flexible container 24. The device 10 in all modes has a fastener 14 extending from an opposite side of the endwall 29, such as a ring connector or a snap hook, which adapts a first end of the device 10 to removably engage to a connector on an animal collar such as a ring thereon. On the device 10 at a second end of the flexible leash member 12 is located a handle 16 for the user to grip the second end of the leash member 12.

Running axially within an axial passage 18 formed in the elongated flexible leash member 12 is slidably positioned, an elastic member such as an elastic cord 20 formed of rubber rope or similar elastic material which will impart a bias when stretched. The elastic cord 20 is engaged at a second end to the leash member 12 at or adjacent the handle 16 end, and at a first end or at a mid portion, to a gripping connector such as a ring 22 such as in FIGS. 2-3. This gripping connector such as the ring 22 as noted herein is employed by a user to pull the leash member 12 to the folded contracted configuration within the flexible container 24 by exerting additional biasing force to the elastic cord 20.

This elastic cord 20 is positioned in a slidable engagement axially in a passage 18 formed into or within the flexible leash member 12. The elastic cord 20 when not elongated by force on both ends of the surrounding flexible leash member 12, such as an animal pulling thereon, will elastically retract itself and the leash member 12 to a contracted configuration of FIG. 3 where the leash member 12 and elastic cord 20 are positioned within the flexible container 24. This is accomplished as the contracting elastic cord 20 pulls the leash member 12 and folds it into the flexible container 24 which is formed of a surrounding flexible sidewall 28 extending from an endwall 29, where the flexible sidewall 28 forms and surrounds an interior cavity 26.

In moving from the elongated configuration of the device 10 in FIG. 1, toward the contracted configuration of the device 10 shown in FIG. 3, the elastic cord 20 will contract and constantly bias the flexible leash member 12 to contract to a compacted state and fold into the interior cavity 26 such as shown in FIG. 2. This biasing of the cord 20 causes the leash member 12 to fold and be pulled into the interior cavity 26 of the flexible container 24 as shown in FIG. 3, where the leash member 12 and elastic cord 20 have fully contracted into the interior cavity 26. The handle 16 portion may need to be tucked into the interior cavity 26 by folding it therein but such is easily accomplished once the leash member 12 has been pulled therein by the biasing of the elastic cord 20.

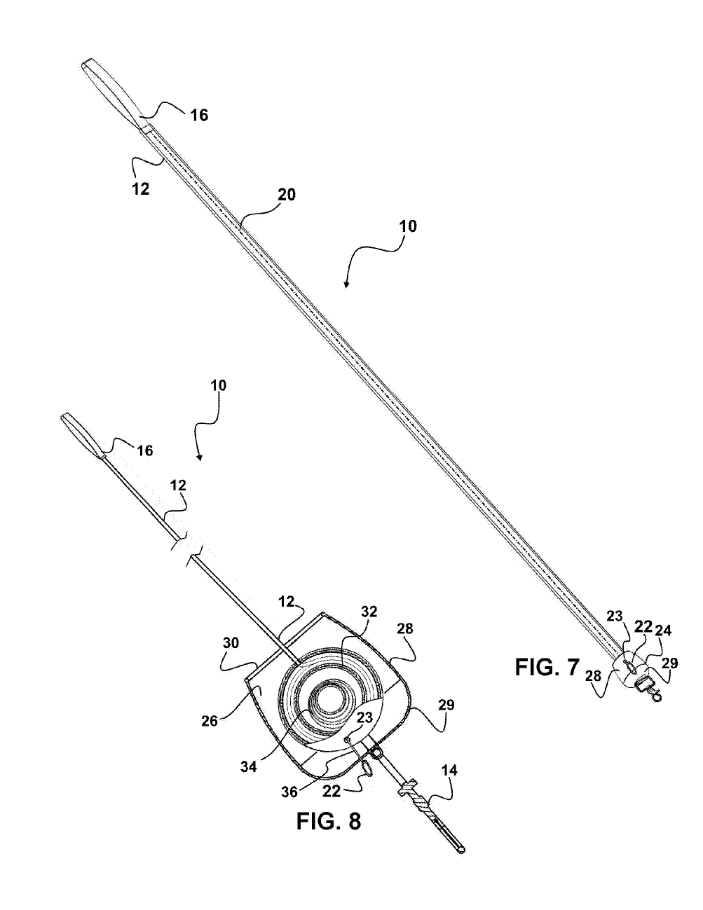

Thus, the flexible leash member 12 is always under a bias to contract from an elongated configuration of FIG. 1 and FIG. 7, by folding and contracting as shown in FIG. 2, even when the device 10 is in operative engagement to an animal such as a dog. This constant bias of the elastic cord 20 where the leash member 12 is in the elongated configuration is preferred because it imparts a slight but not overpowering pull on the animal leash to which it engages. In experimentation, such a constant but slight bias has been found to cause the animal to better maintain a walking speed substantially the same as the leash holding person.

In a preferred mode of the device 10, a first end of the elastic cord 20 can be engaged with a ring 22 or user actuable connector such as a clip or loop. The actuable connector such as the ring 22, is particularly preferred as it allows the user to pull the semi-retracted flexible leash member 12, completely into the interior cavity 26 of the flexible container 24 should the material forming the leash member 12 contract, but not fully position itself completely inside the interior cavity 26.

The flexible container 24 is positioned adjacent the first end of the leash member 12 and the fastener 14 extending from the exterior of the endwall 29 which adapts the first end of the device 10 for removable engagement with an animal collar (not shown but well known). The flexible container 24 has the noted interior cavity 26 with a volume thereof, formed by the endwall 29 and surrounding flexible sidewall 28.

In the compact state, the leash member 12 will substantially entirely retract into the interior cavity 26 where after a short pull upon the ring 22 or other user actuable connector, will complete the retraction. A closure 30 such as an elastic band, or zipper, or hook and loop fabric, or draw string, may be positioned at an open end of the interior cavity 26 of the flexible container 24 defined by a distal end of the sidewall 28 opposite a first end thereof connected with the endwall 29. Such will thereby allow the user to removably close the flexible container 24 once the entire flexible leash member 12 is contracted into the flexible container 24.

This flexible container 24 with flexible sidewall 28 extending from a flexible endwall 29, is preferred in all modes of the device 10 because it is much easier to place in a confined area such as a purse or pocket, and once so positioned, adapt in shape and size to those confines. Textile fabric such as rip stop or flag and banner material work well for forming the flexible container 24 because such fabric is strong but very thin and folds easily to adapt the shape of the flexible container 28 to its surroundings. Of course other woven and non woven materials as would occur to those skilled in the art are anticipated for forming the flexible container 14. A hardened non flexible container was found initially not to provide this utility.

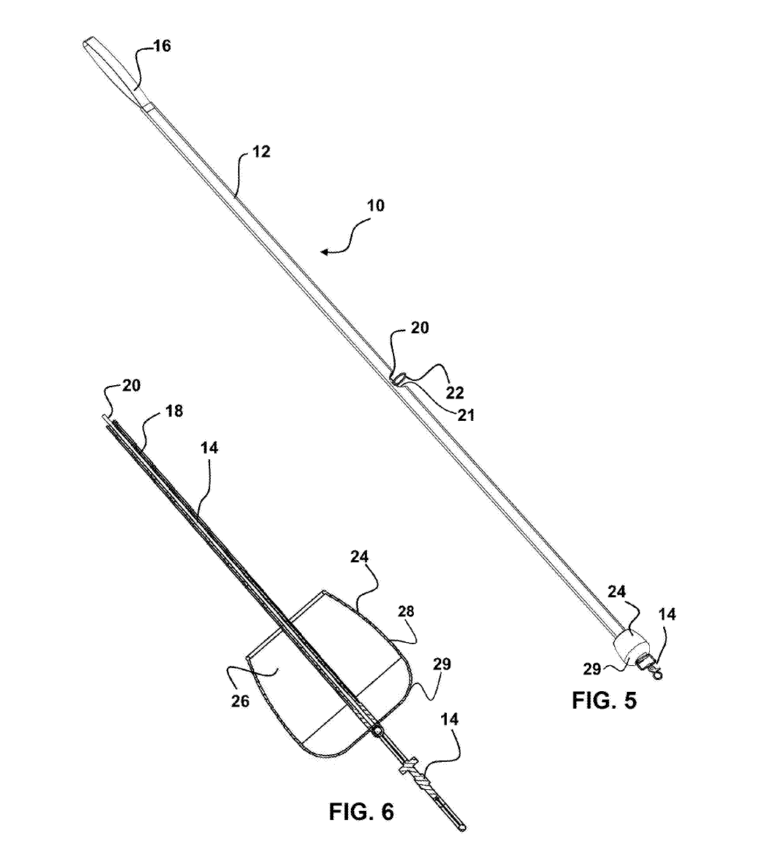

In another mode of the self-retracting leash device 10 herein shown in FIGS. 5 and 6, the elongated flexible leash member 12 also has the passage 18 running axially in-between a first end and second end of the device 10. Situated at a first end is the fastener 14 which adapts the first end of the device 10 to removably engage a connector on an animal collar. At the second end opposite the first end, is located the handle 16 for gripping by the user during use in the elongated configuration. Positioned adjacent the fastener 14 at the first end is located the flexible container 24 which also has an interior cavity 26 formed by surrounding flexible sidewall.

Within the axial passage 18 of the flexible leash member 12 is located the elastic pull cord 20 or the like. At a central position, between the first end and second end of the flexible leash member 12, is located a grab point 21 where the user may grip a ring 22 or a similar gripping connector which is engaged with the centrally positioned elastic member or pull cord 20. Pulling the ring 22 while holding the central portion of the flexible leash member 12 causes the flexible leash member 12 to retract into the interior cavity 26 of the flexible container 24.

Shown in FIG. 7, is a mode of the device 10 herein which has the flexible leash member 12 shown in an elongated configuration which is constantly biased to the contracted configuration by the elastic member 20 running axially from the second end of the leash member 12 and device 10 at the handle 16 to the first end of the device 10 where the leash member 12 engages to the interior cavity 26 of the flexible container 24. In this mode, the elastic member 20 communicates through an aperture 23 in the flexible sidewall 28 to the ring 22 which being larger than the aperture 23 will be pulled against but not pass through the aperture 23 in the sidewall 28. This positions the ring 22 at all times adjacent the exterior surface of the sidewall 28 for use by the user in pulling the folded leash member 12 into the interior cavity 26. The bias on the leash member 12 to contract is maintained in the same fashion noted above.

In FIG. 8 is shown the device 10 where the constant bias imparted on the leash member 12 is provided by a biased roller 32 which is biased to wind up the engaged leash member 12 thereon by a biasing member 34 such as a coiled spring. In this mode, the constant bias on the leash member 12, to collapse from the elongated position such as in FIG. 1 or 5 or 7, to the compacted configuration where the leash member 12 is within the interior cavity 26 of the flexible container 24, is provided by the biasing member 34 acting on the roller 32 to rotate and wind up the leash member 12 thereon. The constant bias is also imparted to the leash member 12 when in an engagement to a collar as in other modes to help restrain the animal by urging the animal to maintain the same speed as the walking user.

In FIG. 8 is also shown a ring 22 engaged to a release 36. This optional ring 22 engaged to the release 36 is provided where the roller 32 may be locked to a fixed position so that the bias holding it fixed can be released. A pulling of the ring 22 will actuate the release 36 such as a pawl, and allow the roller 32 to rotate and wind up the flexible leash member 12 thereon, and to just cause the constant bias on the leash member 12 during use.

While all of the fundamental characteristics and features of the self retracting self contained leash have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that upon reading this disclosure and becoming aware of the disclosed novel and useful leash device herein disclosed, that various substitutions, modifications, and variations may occur to and be made by those skilled in the art, without departing from the spirit or scope of the invention. Consequently, all such modifications and variations and substitutions, as would occur to those skilled in the art are considered included within the scope of the retracting leash invention herein as defined by the following claims.

What is claimed is:

1. A self retracting leash apparatus comprising:
a flexible leash member having a first end and a second end;
a flexible container having a flexible endwall and having an interior cavity surrounded by a flexible sidewall extending from said endwall to a distal edge of said sidewall, said distal edge of said sidewall defining an opening to said interior cavity;
said flexible leash extending from said first end in a connection with said endwall, through said opening to a handle at said second end of said leash member;
a fastener extending from said endwall in an opposite direction from said flexible leash, said fastener adapted to removably engage with a collar of an animal;
an elastic cord extending along an axial passage of said leash member between said first end and said second end thereof;
said leash member having an elongated configuration extending for a length of said leash member from said first end to said handle; and
said elastic cord imparting a biasing force to said leash member for an urging thereof from said elongated configuration to a contracted position folded within said interior cavity.

2. The self retracting leash apparatus of claim 1 additionally comprising:
said elastic cord constantly imparting a biasing force to said leash member toward said contracted position, while in said elongated position.

3. The self retracting leash apparatus of claim 1 additionally comprising:
a closure on said distal edge of said endwall, said closure sealing said opening.

4. The self retracting leash apparatus of claim 2 additionally comprising:
a closure on said distal edge of said endwall, said closure sealing said opening.

5. The self retracting leash apparatus of claim 1 additionally comprising:
a gripping member engaged with said elastic cord; and
said gripping member adapted for pulling thereon by a user to increase said biasing force to urge said leash member to said contracted position.

6. The self retracting leash apparatus of claim 2 additionally comprising:
a gripping member engaged with said elastic cord; and
said gripping member adapted for pulling thereon by a user to increase said biasing force to urge said leash member to said contracted position.

7. The self retracting leash apparatus of claim 3 additionally comprising:
a gripping member engaged with said elastic cord; and
said gripping member adapted for pulling thereon by a user to increase said biasing force to urge said leash member to said contracted position.

8. The self retracting leash apparatus of claim 4 additionally comprising:
a gripping member engaged with said elastic cord; and
said gripping member adapted for pulling thereon by a user to increase said biasing force to urge said leash member to said contracted position.

9. The self retracting leash apparatus of claim 5 wherein said elastic cord extends from said first end of said leash member through an aperture formed in one of said sidewall or said endwall to a first end of said elastic cord; and
said gripping member is engaged to said first end of said elastic cord.

10. The self retracting leash apparatus of claim 6 wherein said elastic cord extends from said first end of said leash member through an aperture formed in one of said sidewall or said endwall to a first end of said elastic cord; and
said gripping member is engaged to said first end of said elastic cord.

11. The self retracting leash apparatus of claim 7 wherein said elastic cord extends from said first end of said leash member through an aperture formed in one of said sidewall or said endwall to a first end of said elastic cord; and
said gripping member is engaged to said first end of said elastic cord.

12. The self retracting leash apparatus of claim 8 wherein said elastic cord extends from said first end of said leash member through an aperture formed in one of said sidewall or said endwall to a first end of said elastic cord; and
said gripping member is engaged to said first end of said elastic cord.

13. The self retracting leash apparatus of claim 5 wherein said gripping member is located at a grab point opening located in a central position on said flexible leash member, between the first end and the second end of the flexible leash member.

14. The self retracting leash apparatus of claim 6 wherein said gripping member is located at a grab point opening located in a central position on said flexible leash member, between the first end and the second end of the flexible leash member.

15. The self retracting leash apparatus of claim 7 wherein said gripping member is located at a grab point opening located in a central position on said flexible leash member, between the first end and the second end of the flexible leash member.

16. The self retracting leash apparatus of claim 8 wherein said gripping member is located at a grab point opening located in a central position on said flexible leash member, between the first end and the second end of the flexible leash member.

17. A self retracting leash apparatus comprising:
a flexible leash member having a first end and a second end;
a flexible container having a flexible endwall and having an interior cavity surrounded by a flexible sidewall extending from said endwall to a distal edge of said sidewall, said distal edge of said sidewall defining an opening to said interior cavity;
a fastener extending from said endwall in an opposite direction from said flexible leash, said fastener adapted to removably engage with a collar of an animal;
a roller positioned within said interior cavity of said flexible container;
a biasing member engaged to impart rotation to said roller;
said flexible leash extending from said first end in a connection with said roller, through said opening, to a handle at said second end of said leash member;
said leash member having an elongated configuration extending for a length of said leash member from said first end to said handle; and
said roller imparting a biasing force to said leash member for an urging thereof from said elongated configuration to a contracted position rolled upon said roller within said interior cavity.

18. The self retracting leash apparatus of claim 17 additionally comprising:
said roller constantly imparting said biasing force to said leash member toward said contracted position, while in said elongated position.
